(19) United States
(12) Patent Application Publication
(10) Pub. No.: US 2026/0211688 A1
(43) Pub. Date: Jul. 23, 2026

(54) DYNAMIC BASIC INPUT/OUTPUT SYSTEM TRANSFORMATION

(71) Applicant: DELL PRODUCTS L.P., Round Rock, TX (US)

(72) Inventors: Chan-Wei Chen, Wugu (TW); Che-Chang Lu, New Taipei City (TW)

(21) Appl. No.: 19/032,342

(22) Filed: Jan. 20, 2025

(51) Int. Cl. G06F 9/4401

(52) U.S. Cl. CPC G06F 9/4403

(57) ABSTRACT

An information handling system is configured to classify each of firmware volumes included in a basic input/output system (BIOS) image into categories according to a boot mode and to select the boot mode for execution from at least two boot modes, wherein each of the boot modes comprising a subset of a plurality of firmware volumes classified into a category of the categories. The information handling system is also configured to execute the boot mode selected.

### FIELD OF THE DISCLOSURE

The present disclosure generally relates to information handling systems, and more particularly relates to a dynamic basic input/output system (BIOS) transformation.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

An information handling system is configured to classify each of firmware volumes included in a basic input/output system (BIOS) image into categories according to a boot mode and to select the boot mode for execution from at least two boot modes, wherein each of the boot modes comprising a subset of a plurality of firmware volumes classified into a category of the categories. The information handling system is also configured to execute the boot mode selected.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system adapted for a dynamic basic input/output system (BIOS) transformation, according to an embodiment of the present disclosure;

FIG. 2 is a block diagram illustrating stages for a dynamic BIOS transformation, according to an embodiment of the present disclosure;

FIG. 3 is a flowchart of a method for a dynamic BIOS transformation, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

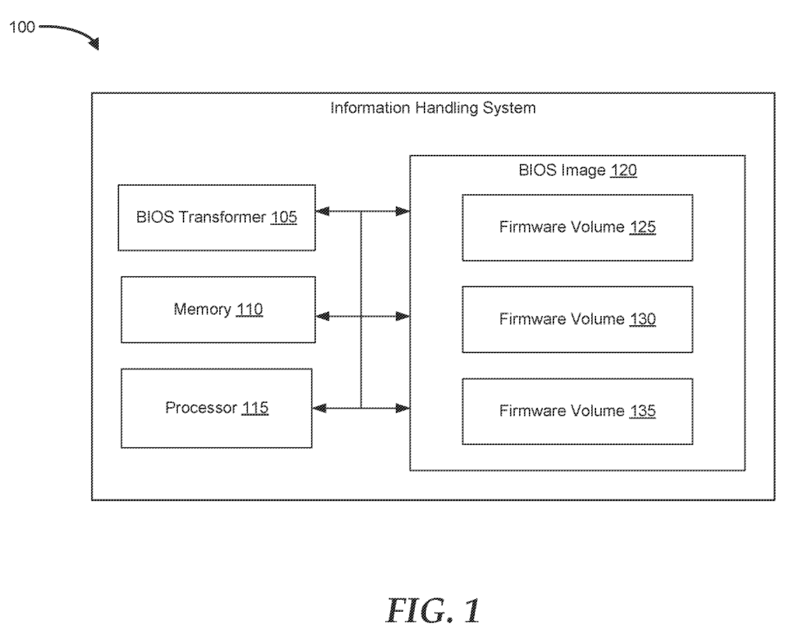

FIG. 1 illustrates a portion of an information handling system 100 for a basic input/output system (BIOS) transformation, according to an embodiment of the present disclosure. A key component of an information handling system is a BIOS, which may be a system, device, or apparatus configured to identify test, and/or initialize one or more resources of an information handling system. The BIOS may include a boot firmware configured to be a first code executed by a processor of an information handling system when the information handling system is booted, restarted, and/or powered on. As part of its initialization functionality, the BIOS code may be configured to set components of the information handling system into a known state, so that one or more applications, such as an operating system or other programs stored on compatible media may be executed by the processor and given control of the information handling system and its various components. However, as the BIOS is becoming increasingly complex with pre-boot feature sets and advanced serviceability features, the boot time of the information handling system is undesirably increased.

In addition, an information technology specialist may need to configure the BIOS of information handling systems with different platforms. As such, the information technology specialist may want to be able to configure the BIOS with platform-specific features, which will result in a more optimized and faster boot time. Accordingly, the present disclosure provides a system and method to transform the BIOS to reflect platform-specific features which can be based according to a user’s preference or need.

Information handling system 100 includes a BIOS transformer 105, a memory 110, a processor 115, and a BIOS image 120. BIOS image 120 includes firmware volumes 125, 130, and 135. BIOS image 120 may be coupled to BIOS transformer 105, memory 110, and processor 115. However, any variety of connections between BIOS image 120 and the other components are envisioned as falling within the scope of the present disclosure. In addition, connections between these components may be omitted for descriptive clarity. Further, the operations described herein as being performed by BIOS transformer 105 and BIOS image 120 may be performed or executed by processor 115.

BIOS transformer 105 may be executed at an early stage of a boot process. For example, BIOS transformer 105 may be executed at a pre-extensible firmware interface (EFI) initialization environment (PEI) phase and/or a driver execution environment (DXE) phase through a boot device selection (BDS) phase. BIOS transformer 105 may scan one or more firmware volumes included in a BIOS image and then read or collect information associated with each one of the firmware volumes. BIOS transformer 105 may then log the firmware volume-related information in a list, table, or similar data structure. In addition, BIOS transformer 105 may determine platform-specific information associated with information handling system 100, such as its platform identifier and current boot mode. The platform-specific information may also be logged in the same data structure and stored in memory 110. In addition, one or more system boot policies may also be stored in the memory. Based on the logged information and/or system boot policies, BIOS transformer 105 may determine the firmware volume visible to the BIOS for execution according to a pre-defined current boot mode of the information handling system. Accordingly, BIOS transformer 105 may hide the other firmware volumes from the BIOS.

In one embodiment, the BIOS boot modes may be configured in a BIOS setup by a system administrator or user of the information handling system. However, a default BIOS boot mode may also be configured during the manufacture of the information handling system. In one example, the BIOS boot modes include a fast boot mode and a normal boot mode. However, there may be more than two boot modes, such as a fast boot mode, a normal boot mode, and a safe boot mode. The fast boot mode is an accelerated boot mode that is faster than the normal boot mode because only essential firmware images may be executed, which is a subset of the firmware volumes of the source pool. The essential firmware volumes may also be a subset of the firmware volumes associated with the normal boot mode. For example, if the boot mode is “fast boot,” then BIOS transformer 105 may hide firmware volumes that are classified as optional. Because the optional firmware volumes are hidden, these firmware volumes may not be loaded, authenticated, and executed, which can save time during the boot process. In another example, BIOS transformer 105 may be configured to hide firmware volumes with feature sets that are not for a specific platform from a multi-platform supported BIOS image. For example, a BIOS transformer may hide a firmware volume that supports Bluetooth^{®} technology during the boot process if this specific platform does not have the Bluetooth^{®} feature enabled during the boot process or if the user wants this particular feature disabled.

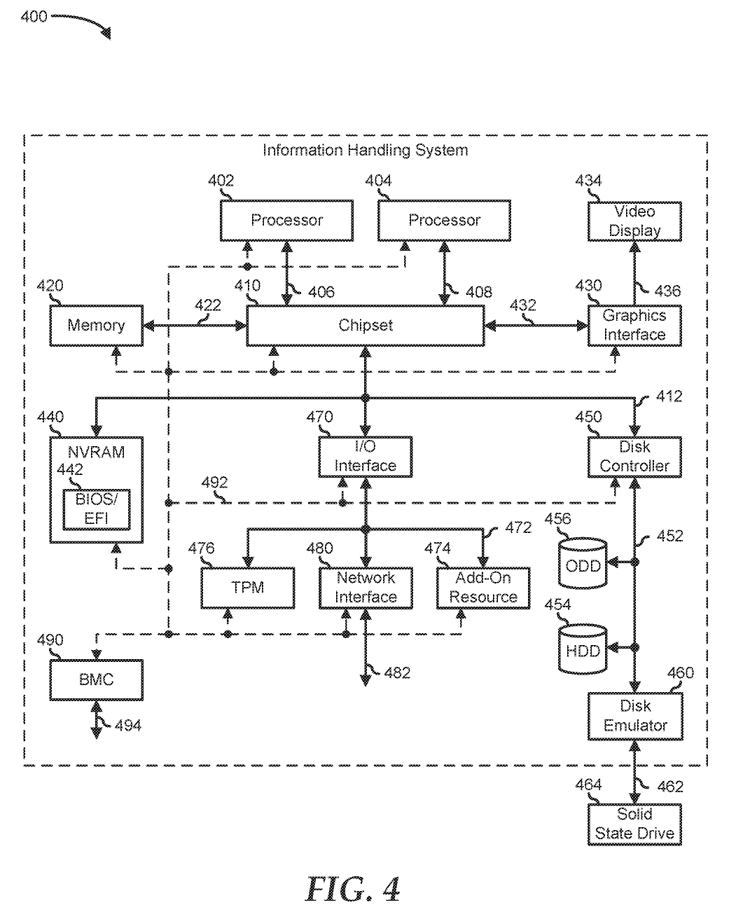

Memory 110, which is similar to memory 420 of FIG. 4, may be communicatively coupled to processor 115 and may include any system, device, or apparatus operable to retain program instructions or data for a period of time. Memory 110 may include a random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to information handling system 100 is turned off.

Processor 115, which is similar to processors 402 and 404 of FIG. 4, may include any system, device, or apparatus operable to interpret and/or execute program instructions and/or process data, and may include, without limitation, a microprocessor, microcontroller, digital signal processor, application specific integrated circuit (ASIC), or any other digital or analog circuitry configured to interpret, and/or execute program instructions and/or process data stored in memory and/or another component of information handling system.

BIOS image 120 is a file that includes a BIOS firmware, which is similar to a BIOS/EFI 442 of FIG. 4 and may include any system, device, or apparatus configured to identify, test, and/or initialize information handling resources of information handling system 100 and/or initialize interoperation of information handling system 100 with other information handling systems. “BIOS” may broadly refer to any system, device, or apparatus configured to perform such functionality, including without limitation a Unified Extensible Firmware Interface (UEFI). In some embodiments, the BIOS firmware, or simply the BIOS, may be implemented as a program of instructions that may be read by and executed on processor 115 to carry out the functionality of the BIOS. In these and other embodiments, the BIOS may be configured to be the first code executed by processor 115 when information handling system 100 is booted and/or powered on. As part of its initialization functionality, code for the BIOS may be configured to set components of information handling system 100 into a known state, so that one or more applications, such as an operating system or other application programs, stored on compatible media may be executed by processor 115 and given control of information handling system 100.

BIOS image 120 may be embodied in its dedicated memory accessible to processor 115. For example, in some embodiments, BIOS image 120 may be embodied in a non-volatile memory, such as a serial peripheral interface (SPI) flash memory. BIOS image 120 may be segmented into a plurality of firmware volumes that include firmware volumes 125, 130, and 135. The firmware volumes may include executable code volumes and data volumes that can control certain hardware elements of an information handling system. The executable code may be executed during initialization or a boot process, such as power-on self-test (POST).

During a build process, each one of the firmware volumes may be classified into a category. For example, each one of the firmware volumes may be classified as either essential or optional. For example, firmware volume 125 may be classified as essential while firmware volumes 130 and 135 may be classified as optional. The firmware volumes classified as essential may include a minimal number of required drives for a particular platform to boot and work normally. The firmware volumes classified as optional may include value-added features, peripheral drivers, platform-specific drivers, etc., which are not required for the platform to boot and work normally.

With more and more features added to the BIOS image, the number of firmware volume increases, which also increases the boot time of an information handling system. Accordingly, quite a number of users typically want to have a fast boot mode on certain occasions to be able to boot their computing devices faster. However, a user may also want to disable the fast boot mode in certain situations, such as when the user needs a particular BIOS feature.

Those of ordinary skill in the art will appreciate that the configuration, hardware, and/or software components of information handling system 100 may vary. For example, the illustrative components within information handling system 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

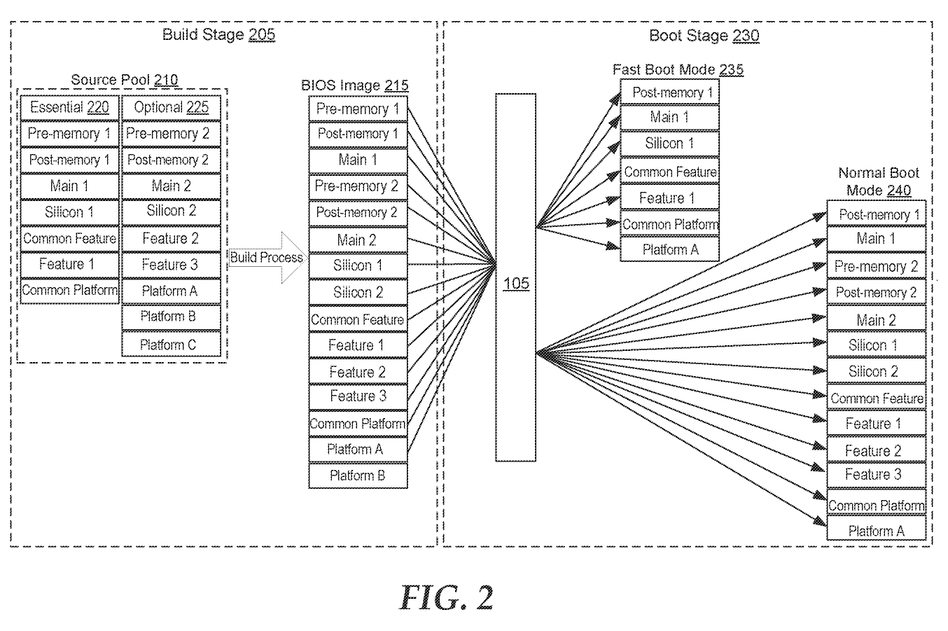

FIG. 2 illustrates a portion of stages associated with the transformation of a BIOS of an information handling system, according to an embodiment of the present disclosure. The stages include a build stage 205 and a boot stage 230. Build stage 205 process includes scanning a source pool 210 of firmware volumes for a shared platform. A build transformer application or module, such as build BIOS transformer 105 of FIG. 1, may group the firmware volumes into various groups, such as pre-memory, post-memory, main, silicon, common feature, common platform, core, etc. The build transformer may classify each group of the firmware volumes into at least two categories: essential and optional, such as an essential 220 and an optional 225, respectively. The essential firmware volume includes a minimal number of required drivers to boot the information handling system and may be associated with a fast boot mode. In addition, each group of firmware volumes may include essential and optional code and data volumes. For example, firmware volumes included in a pre-memory group may be subdivided into pre-memory 1 and pre-memory 2, wherein pre-memory 1 may be classified as essential pre-memory firmware volumes while pre-memory 2 may be classified as optional pre-memory firmware volumes.

To generate a BIOS image 215, the BIOS transformer may include firmware volumes in essential 220 and some of the firmware volumes in optional 225 based on a specification or system policy. BIOS image 215 may include firmware volumes for different platforms. In this example, BIOS image 215 includes firmware volumes for platforms A and B, but not platform C. However, based on a current platform of the information handling system, platform-specific firmware volume may be utilized during the boot process. For example, firmware volumes included in boot stage 230 may include firmware volumes for platform A but not platform B even though the firmware volume for platform B is included in BIOS image 215.

The firmware volumes utilized during the boot process may be based on a boot mode of the information handling system, such as a fast boot mode 235 and a normal boot mode 240. A user may switch between boot modes, such as via a BIOS setup interface. Fast boot mode 235 may utilize a minimal number of firmware volumes to successfully boot the information handling system. Normal boot mode 240 may include additional firmware volumes, such as additional features that are wanted or needed by the user. As such, not all of the firmware volumes that have been classified as optional are included in the normal boot mode.

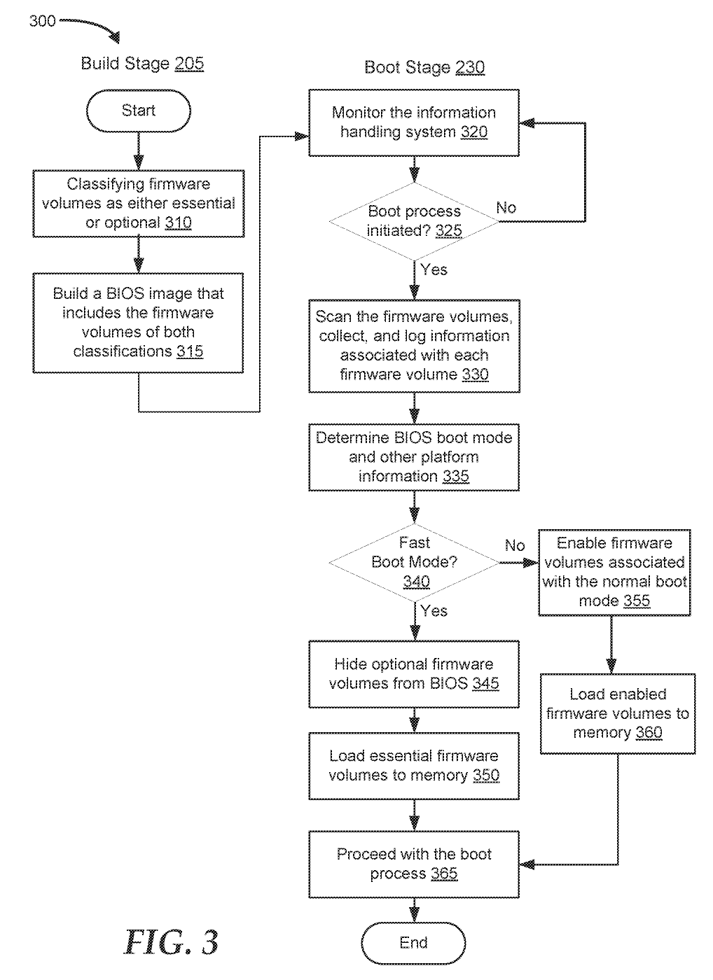

FIG. 3 illustrates a flowchart of a method 300 for BIOS transformation, according to an embodiment of the present disclosure. Method 300 may be performed by any suitable component of information handling system 100 including, but not limited to, the BIOS transformer of FIG. 1. While embodiments of the present disclosure are described in terms of the components of information handling system 100 of FIG. 1, it should be recognized that other components may be utilized to perform the described method. One of skill in the art will appreciate that this flow diagram explains a typical example, which can be extended to applications or services in practice. It will be readily appreciated that not every method block set forth in this flow diagram is always necessary and that certain blocks of the methods may be combined, performed simultaneously, in a different order, or perhaps omitted, without varying from the scope of the disclosure.

Method 300 typically starts at block 310 during build stage 205, wherein a BIOS transformer may classify firmware volumes or groups of firmware volumes into either essential or optional. The method may proceed to block 315, where the BIOS transformer may build a BIOS image for an information handling system, wherein the BIOS image includes the firmware volumes of both classifications. The method may proceed to block 320 where the BIOS transformer may monitor the information handling system for signs of initialization of a boot process. The method may proceed to a decision block 325.

At decision block 325, the BIOS transformer may detect whether the boot process is initiated. For example, the BIOS transformer may detect a power-on self-test (POST) or activation of various hardware components in preparation for launching an operating system. The information handling system may enter the boot process when powered on, rebooted, or any other system start-up process. If the BIOS transformer detects that the boot process of the information handling system is initiated, then the “YES” branch is taken, and the method may proceed to block 330. If the BIOS transformer detects that the boot process of the information handling system is not initiated, then the “NO” branch is taken, and the method may proceed to block 320.

At block 330, the BIOS transformer may scan the firmware volumes included in the BIOS image and log information associated with the firmware volumes, such as on a list, table, or something similar. For example, the information may include whether the firmware volume is essential or optional. The information may also include a platform identifier that the firmware volume is associated with. The method may proceed to block 335 where the BIOS transformer may determine BIOS boot mode and other platform information associated with the information handling system based on the logged information. For example, the BIOS transformer may determine whether the current boot mode is the fast boot mode or the normal boot mode. The method may proceed to decision block 340.

At decision block 340, the BIOS transformer may determine whether the boot mode is a fast boot mode. If the boot mode is a fast boot mode, then the “YES” branch is taken, and the method proceeds to block 345. If the boot mode is not a fast boot mode, then the “NO” branch is taken, and the method may proceed to block 355. At block 345, the BIOS transformer may hide optional firmware volumes from the BIOS. The BIOS transformer may also hide firmware volumes that are not associated with the platform of the information handling system. In addition, the BIOS transformer may enable essential firmware volumes. In another embodiment, the essential firmware volumes may be enabled by default. The method may proceed to block 350 where the BIOS transformer may load essential firmware volumes to memory. The method may proceed to block 365.

At block 355, the BIOS transformer may enable essential and platform-specific firmware volumes. The BIOS transformer may also enable other firmware volumes associated with the normal boot mode. As such, the normal boot mode may include firmware volumes associated with the fast boot mode and firmware volumes that are associated with the normal boot mode, such as platform-specific firmware volumes. The platform-specific firmware volumes and the other firmware volumes that are not essential may have been classified as optional firmware volumes. The BIOS transformer may hide the firmware volumes that are not associated with the normal boot mode nor enabled. The method may proceed to block 360 where the BIOS transformer may load the enabled firmware volumes into memory. The method may proceed to block 365 where the BIOS may proceed with the boot process. Afterwards, the method may end.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes BIOS/EFI module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (x4) PCIe adapter, an eight-lane (x8) PCIe adapter, a 16-lane (x16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth^{®} or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out of band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell^{®} Remote Access Controller (iDRAC).

Management interface 492 represents one or more out-of-band communication interfaces between BMC 490 and the elements of information handling system 400, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish^{®} interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus BMC 490 can communicate with the management system via network interface 494 while the resources of information handling system 400 are powered off. Here, information can be sent from the management system to BMC 490 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 400 can include multiple central processing units (CPUs) and redundant bus controllers. One or more components can be integrated together. Information handling system 400 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, blocks 330 and 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an (ASIC), a Field Programmable Gate Array (FPGA), a structured ASIC, or a device embedded on a larger chip), a card (such as a Peripheral Component Interface (PCI) card, a PCI-express card, a PCMCIA card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
classifying each of a plurality of firmware volumes included in a basic input/output system (BIOS) image into a category;
selecting a boot mode for execution from at least two boot modes, wherein the boot mode includes a subset of the firmware volumes that have been classified according to the category; and
executing the boot mode selected.

2. The method of claim 1, wherein a default boot mode is a fast boot mode.

3. The method of claim 1, wherein the boot modes include a fast boot mode and a normal boot mode.

4. The method of claim 3, wherein the fast boot mode includes firmware volumes that are classified as essential.

5. The method of claim 3, wherein the normal boot mode includes firmware volumes that are classified as essential and a platform-specific firmware volume.

6. The method of claim 1, further comprising scanning firmware volumes included in the BIOS image.

7. The method of claim 1, further comprising identifying information associated with each firmware volume included in the BIOS images.

8. The method of claim 7, further comprising storing the identified information in a data structure.

9. An information handling system, comprising:
a processor; and
a memory coupled to the processor, the memory having program instructions stored thereon that upon execution cause the processor to:
classify each of a plurality of firmware volumes included in a basic input/output system (BIOS) image into a category;
select a boot mode for execution from at least two boot modes, wherein the boot mode includes a subset of the firmware volumes that have been classified according to the category; and
execute the boot mode selected.

10. The information handling system of claim 9, wherein a default boot mode is a fast boot mode.

11. The information handling system of claim 9, wherein the boot modes include a fast boot mode and a normal boot mode.

12. The information handling system of claim 11, wherein the firmware volumes that are classified as essential are associated with the fast boot mode.

13. The information handling system of claim 11, wherein the normal boot mode includes firmware volumes that are essential and platform-specific firmware volumes.

14. A non-transitory computer-readable medium to store instructions that are executable to perform operations comprising:
classifying each of a plurality of firmware volumes included in a basic input/output system (BIOS) image into a category;
selecting a boot mode for execution from at least two boot modes, wherein the boot modes include a subset of the firmware volumes that have been classified according to the category; and
executing the boot mode selected.

15. The non-transitory computer-readable medium of claim 14, wherein a default boot mode is a fast boot mode.

16. The non-transitory computer-readable medium of claim 14, wherein the boot modes include a fast boot mode and a normal boot mode.

17. The non-transitory computer-readable medium of claim 16, wherein the firmware volumes that are essential are associated with the fast boot mode.

18. The non-transitory computer-readable medium of claim 16, wherein the normal boot mode includes firmware volumes that are essential and a platform-specific firmware volume.

19. The non-transitory computer-readable medium of claim 14, wherein the operations further comprise scanning firmware volumes included in the BIOS image.

20. The non-transitory computer-readable medium of claim 14, wherein the operations further comprise identifying information associated with each firmware volume.
